(19) United States
(12) Patent Application Publication
(10) Pub. No.: US 2012/0125700 A1
(43) Pub. Date: May 24, 2012

(54) Electric and other vehicles with wind turbine charging devices

(76) Inventor: Rudolph Volroy Bailey, SR., Ashburn, VA (US)

(21) Appl. No.: 12/927,718

(22) Filed: Nov. 22, 2010

(51) Int. Cl. B60K 16/00

(52) U.S. Cl. 180/2.2

(57) ABSTRACT

A new method for a continuous operating electric vehicle has been disclosed an electric vehicle can be made to operate on a consistent basis by installing a wind turbine generator as a charging device, as the vehicle moves along the turbine delivers the charging volts and amps needed to charge the batteries.

### BACKGROUND

This version of the invention is concerned with the field of wind turbines for transportation devices. More specifically this version of the invention is designed to recharge the batteries in the electric cars or to provide electrical energy where needed.

### PRIOR ART

A variety of electric cars are on the market but they depend on gasoline to supply power when the battery get's weak, or to be plugged in to a stationary power source. My invention however can supply this needed power by installing a wind turbine under the hood to act as the said power source. As the vehicle moves along the invention will supply more power as needed, as the blades move faster and faster.

### SUMMARY

The present version of the invention, which will be described in greater details herein after, relates to the field of power sources operated by batteries and by wind turbines to deliver clean and green electrical energy to electric cars and electrical transportation devices; who's batteries can be charged by wind turbines as the vehicle moves along, or be used in other ways for other purposes. In this case the batteries would be the main source of power and as the vehicle drives the wind turbine would supply the charge for the batteries.

According to a typical embodiment the vehicle would contain batteries or battery packs wired to desired volts and amps and an appropriate charger and an electric motor optional transmission and drive train and wind turbine., or other versions within the scope of the invention. Existing electric vehicles could also be converted to this principle.

In order that the detailed description of the invention may be better understood and that the present contribution to the art can be more fully appreciated, additional features of the invention will be described hereinafter. It should be appreciated by those skilled in the art that the conception and disclosed specific method and structures may be readily utilized as a basis for modifying or designing other structures for carrying out the same purpose of the present invention. It should be realized by those skilled in the art That such equivalent methods and structures do not depart from the spirit and scope of the invention.

In this respect, before explaining at least one embodiment of the invention in detail it is to be understood that the invention is not limited in its application to the detail of construction and to the Arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is Based, may readily be utilized as a basis for designing of other structures, methods and systems for carrying out the several purposes of the present invention.

Further, the purpose of the foregoing abstract is to enable the US patent and trademark office and the public generally, and especially the scientist and, and engineers and practitioners in the art who are not familiar with patent or legal terms or phraseology, to determine quickly from a cursory inspection the nature and essence of the technical disclosure of the application. The abstract is neither intended to define The invention of the application nor is it intended to be limiting as to the scope of the invention in any way.

Accordingly, it is the object of my version of the invention to provide low-cost, easy-to-manufacture and easy-to-market electric transportation devise.

A further object of my version of the invention is to provide an easy-to-use and versatile electric car with its own on board internal charging system that can operate per long periods and 100% pollution free and fuel free.
A significant object of the invention is to provide an alternate relatively self charging electric vehicles for industrial and commercial and private use.

### BRIEF DISCRIPTION OF THE DRAWING

The foregoing and other objects, features and advantages of the invention will become more fully understood from the following description of the preferred embodiment of the invention as illustrated in the accompanying drawings in which like reference characters refer to the same parts throughout different views. The drawings are not necessarily to scale, emphasis instead being placed upon illustrating the principles of the invention.

FIG. 1 is a elevation view of an electric car showing the relationship of all major component parts in relationship to the wind turbine.

FIG. 2 is an elevation view of a tractor with battery rack with sliding draws for power module for 36-volt arrangement each compartment.

### DRAWING REFERENCE NUMERIALS

22 DC Power Module
24 Power Lead
26 Generator Positive Wire
AC Pulley
(CB) Circuit Breaker
(DM) Drive Motor
(BP) Battery Pack
(SS) Start Switch
(D)Drive Motor
(G) Generator
(WT) Wind Turbine
(WH) Wire Harness
(ST) Spare Tire.

### DESCRIPTION OF THE PREFERRED EMBODIMENT

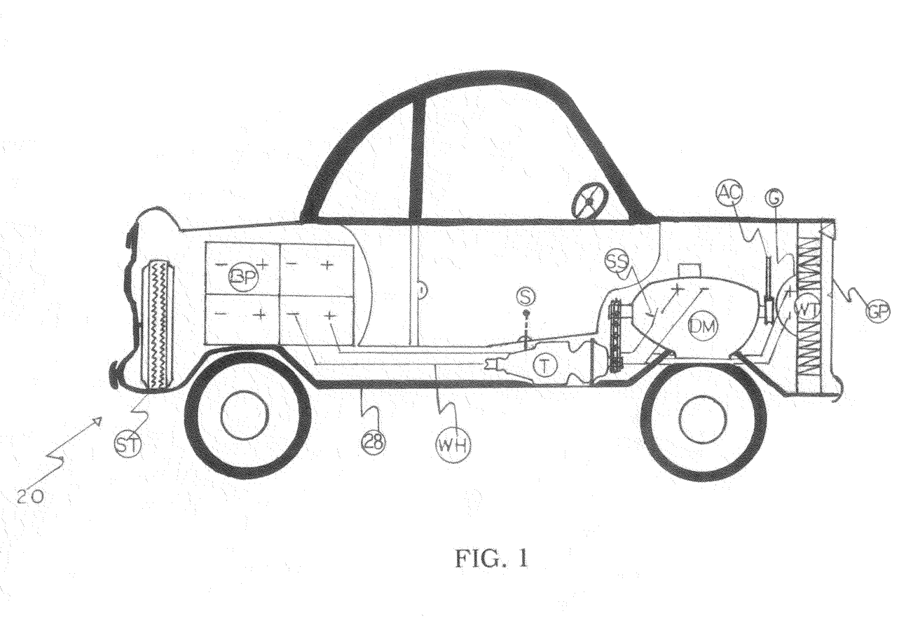

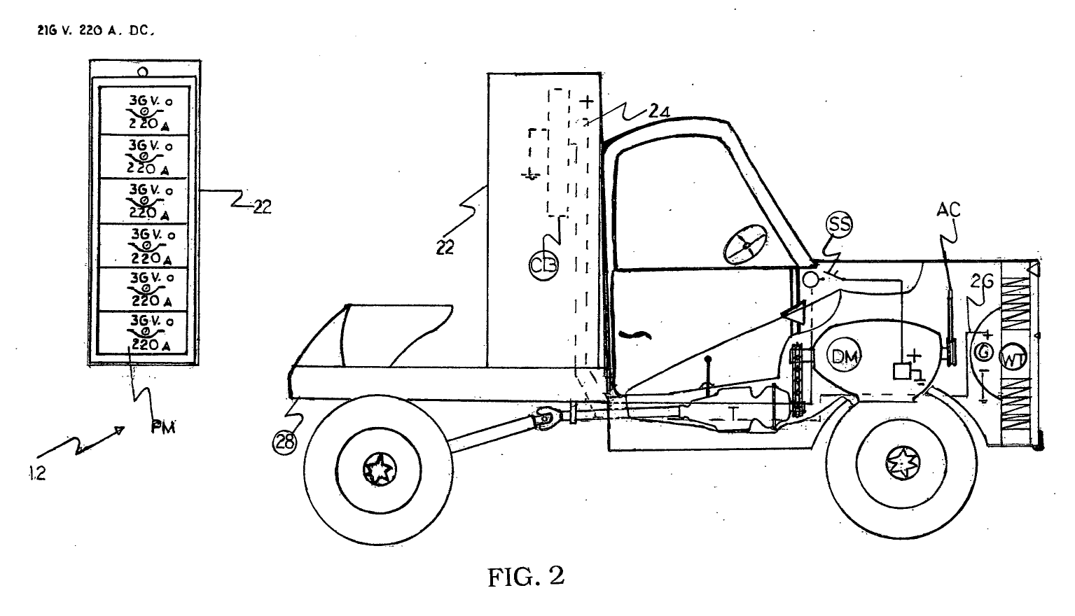

Referring now to the drawings and in particular, to FIG. 1 where there is illustrated a typical embodiment of an self charging electric car 20 the invention is consisted of materials that are light weight and durable and resistant to oxidization and corrosion such as plastic, mild steel carbon steel and composite materials or a Combination thereof standard in the automobile Industry. The invention 20 comprises a main frame 28 With battery pack (BP) of appropriate volts and Amps with drive motor DM of appropriate size enough to power automobile with drive train and transmission (T), wire harness (WH) from drive motor (DM) to battery pack (BP). Generator (G) delivers power to battery charging system which charges the battery as needed as the vehicle drives in the normal way the wind turbine delivers the needed charging volts and Amps to the charging system.
Referring now to FIG. 2 wherein illustrated is a tractor 12 the present invention 12 operates similar to FIG. 1, Power module 22 supplies the higher volts and amps necessary to operate the vehicle Each compartment has three 12-volt battery connected to deliver 36-volts at 220 Amps each individual Compartment can roll out and snap back in place. Additionally any electric car can be converted by just adding the wind turbine.

1. What I claim is a method for converting any electric car into a continus operating vehicle: comprising:
(a) adding a wind turbine to charging system. As the vehicle is driven the vehicle will charge itself.

2. What I claim is an electric car with self charging device comprising:
(a) Installing battery pack connected to electric drive motor and secured to main frame and
(b) wiring to drive motor via starting device and accelerating mechanism and
(c) connecting to transmission and appropriate drive train and
(d) connecting to wind turbine and generator and
(e) connecting to charging system whereby as vehicle is operated wind turbine charges the battery pack thereby vehicle can be operated as it charges itself.
